(19) United States
(12) Patent Application Publication
(10) Pub. No.: US 2025/0124650 A1
(43) Pub. Date: Apr. 17, 2025

(54) REMOVAL OF HEAD MOUNTED DISPLAY FOR REAL-TIME 3D FACE RECONSTRUCTION

(71) Applicant: CANON U.S.A., INC., Melville, NY (US)

(72) Inventor: Xiwu Cao, Irvine, CA (US)

(21) Appl. No.: 18/695,666

(22) PCT Filed: Sep. 29, 2022
(86) PCT No.: PCT/US2022/077260

§ 371 Date: Mar. 26, 2024

Related U.S. Application Data
(60) Provisional application No. 63/250,464, filed on Sep. 30, 2021.

(51) Int. Cl. G06T 17/00; G06T 5/50; G06T 5/77; G06V 10/70; G06V 40/16

(52) U.S. Cl. CPC G06T 17/00; G06T 5/50; G06T 5/77; G06V 10/70; G06V 40/171; G06T 2207/20081; G06T 2207/30201

(57) ABSTRACT

A server and method is provided for removing an apparatus that occludes a portion of a face in a video stream and receives captured video data of a user wearing the apparatus that occludes the portion of the face of the user, obtains facial landmarks representing the entire face of the user including the occluded portion and non-occluded portion of the face of the user, provides one or more types of reference images of the user with the obtained facial landmarks to a trained machine learning model to remove the apparatus from the received captured video data, generates three dimensional data of the user including a full face image using the trained machine learning model and causes the generated three dimensional data of the user to be displayed on a display of the apparatus that occludes the portion of the face of the user.

### CROSS-REFERENCE TO RELATED APPLICATIONS

This application claims the benefit of priority from U.S. Provisional Patent Application Ser. No. 63/250,464 filed on Sep. 30, 2021, the entirety of which is incorporated herein by reference.

### BACKGROUND

### Field

The present disclosure relates generally to video image processing.

### Description of Related Art

Given the big progresses that have been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore to find a way to remove the headset and recover the blocked upper face region from the 3D faces is critical to the overall performance in virtual and/or mixed reality.

There are many approaches available to recover the blocked face region from headset. They can be split into two main categories. A first category is to combine the lower part of face captured in real time with the predicted upper part of face that is blocked by the headset. A second category can be illustrated by the approach where the system predicts the entire face, including both the upper and lower part of the face, without need to merge the real time captured face regions. A system and method described below remedies the defects

### SUMMARY

According to an embodiment, a server is provided for removing an apparatus that occludes a portion of a face in a video stream. The server includes one or more processors and one or more memories storing instructions that, when executed, configure the one or more processors to perform operations. The operations receive captured video data of a user wearing the apparatus that occludes the portion of the face of the user and obtain facial landmarks representing the entire face of the user including the occluded portion and non-occluded portion of the face of the user, and provide one or more types of reference images of the user with the obtained facial landmarks to a trained machine learning model to remove the apparatus from the received captured video data; and generate three dimensional data of the user including a full face image using the trained machine learning model; and cause the generated three dimensional data of the user to be displayed on a display of the apparatus that occludes the portion of the face of the user.

In certain embodiment, the facial landmarks are obtained via live image capture process in real-time. In another embodiment, the facial landmarks are obtained from a set of reference images of the user not wearing the apparatus. In a further embodiment, the server obtains first facial landmarks of a non-occluded portion of the face and obtains second facial landmarks representing the entire face of the user including the occluded portion and non-occluded portion of the face of the user and provides one or more types of reference images of the user with the first and second obtained facial landmarks to a trained machine learning model to remove the apparatus from the received captured video data.

In further embodiments, the trained machine learning model is user specific and trained using a set of reference images of the user to identify facial landmarks in each reference image of the set of references images and predict an upper face image from at least one of the set of reference images used when removing the apparatus that occludes the face of the user. In other embodiments, the model is further trained to use, a live captured image of a lower face region with lower face regions from the set of reference images to predict facial landmarks for an upper face region that corresponds to the live captured image of the lower face region.

According to other embodiments, the generated three dimensional data of the full face image is generated using extracted upper face regions of the set of reference images that are mapped onto the upper face region in the live captured image of the user to remove the upper face region occluded by the apparatus.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1A is graph illustrating ranges of visual perception of humans.

FIG. 1B-1D are results of prior art mechanism for generating images whereby a head mount display has been removed.

FIG. 2. is a graphical representation of a strategy for building a model according to the present disclosure.

FIG. 3 illustrates exemplary pre-capture of images with and without a head mount display unit according to the present disclosure.

FIGS. 4A-4C illustrate an algorithm for generating an image of user presented in virtual reality where the user will appear without a head mount display according to the present disclosure.

FIGS. 5A-5C illustrate exemplary image capture processing used in the head mount display removal processing according to the present disclosure.

FIGS. 6A-6E illustrate models of the face of a user generated based on a captured image according to the present disclosure.

FIG. 7 illustrates a model of the face of a user generated based on a captured image according to the present disclosure.

FIG. 8 a model of the face of a user generated based on a captured image according to the present disclosure.

FIGS. 9A-9D illustrate the results of the processing of the head mount display removal algorithm of the present disclosure.

FIG. 10 is a block diagram detailing the hardware components of an apparatus that executes the algorithm according to the present disclosure.

### DESCRIPTION OF THE EMBODIMENTS

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

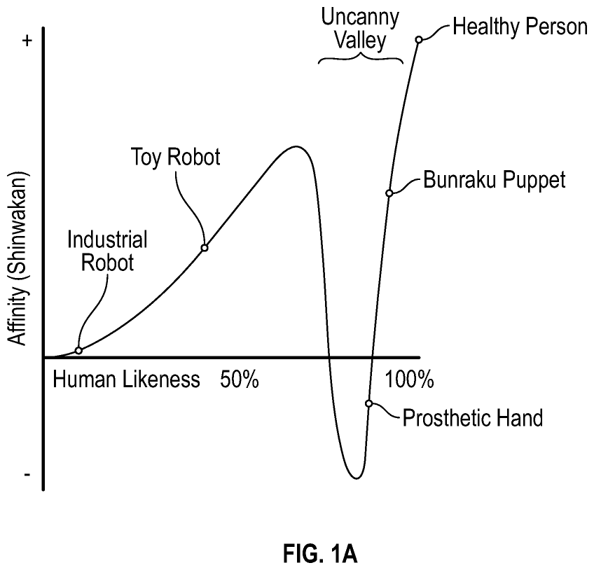

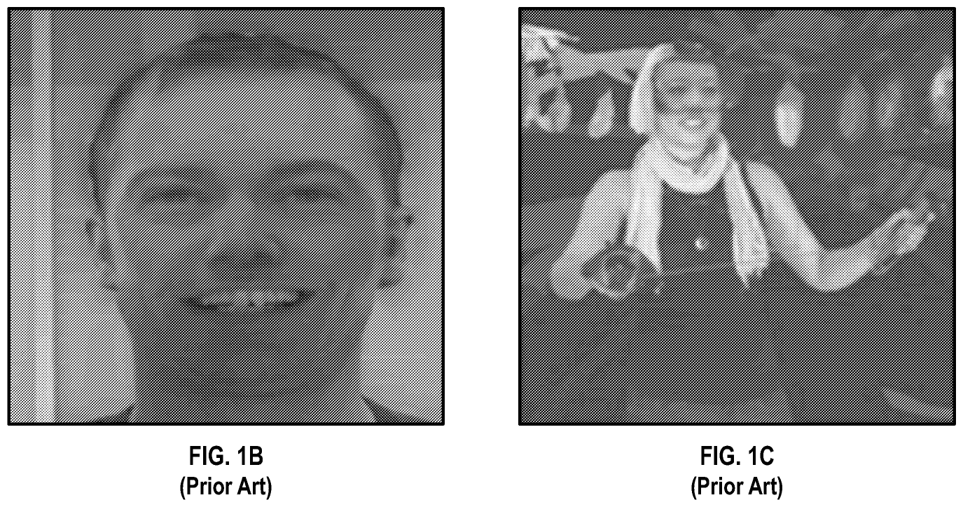

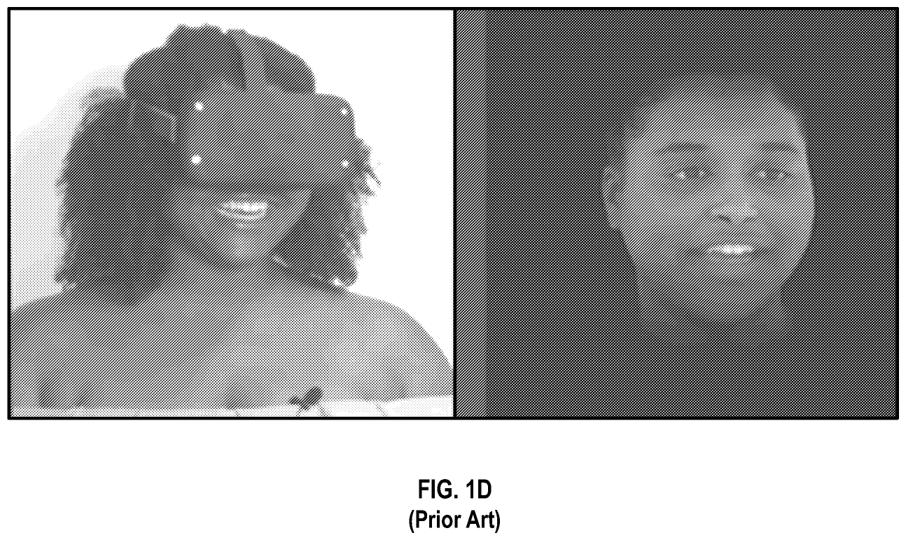

While many approaches are available to recover or replace image data of the upper portion of the face that is occluded by a headset that is worn when engaging in virtual reality, mixed reality and/or augmented reality activity, there are clear problems when considering the human perception phenomenon in the synthesized human 3D face. This is known as the uncanny valley effect. The main issues associated with this type of image processing result from humanoid objects that imperfectly resemble actual human beings provoking uncanny or strangely familiar feelings of eeriness and revulsion in observers. The uncanny valley effect is illustrated in FIG. 1A. As shown in FIG. 1A, the affinity of our emotion will increase when the human-likeness features increase. However, as the human-likeness features further increase, the affinity of our emotion could sink down sharply and trigger a strong negative emotion. This negative emotional feeling is shown in the sharp dip as the amount of human likeness approaches 100% and is labeled as “the uncanny valley”.

The results of image processing of certain mechanisms for correcting the uncanny valley effect are shown in FIGS. 1B-1D labeled as “PRIOR ART”. The results of these prior art processing illustrate the issues associated with image processing for removing a head mount display (HMD) apparatus worn by a user. FIG. 1B illustrates a first solution where an upper portion of the human face covered by an HMD is predicted and combined with a live captured image of the lower face. As shown herein, there is visible lighting difference between the predicted HMD-blocked upper face region and live-captured lower face region can be very easily observed. FIG. 1C demonstrates a modified version the first solution shown in FIG. 1B which adds a some scuba mask effect to make the final output look natural from the perspective of human perception. Both these solutions show that it is very difficult to seamlessly merge the predicted region into the real-captured one and generate an image of acceptable quality. FIG. 1D illustrates third approach that updates both the upper part and lower part of human face as a whole unit from a prediction model. While this image is generated without merging upper and lower parts of the face and therefore eliminate the needs of scuba mask, however, the result still suffers from the uncanny effect since our human are very good in identifying anything unnatural.

The following disclosure details an algorithm for performing HMD removal from a live captured image of a user wearing an HMD which advantageously generates an image that significantly reduces the uncanny valley effect. As described herein, the algorithm illustrates key concepts in establishing how the algorithm obtains or otherwise generates the data used to recover a portion of the users face that is considered the blocked region which is blocked by the HMD headset being worn by the user during the live capture.

In one embodiment, one or more key reference sample images of a user are recorded. These one or more key reference sample images are recorded without the HMD being worn. The one or more key reference sample images are used to build a face replacement model and, for each user, the model built is personalized for that particular user. In this embodiment, the idea is to obtain or otherwise capture and record in memory a plurality of key reference 3D images build the model for the particular individual who is the subject being captured. The ability to obtain as many images of the user as possible in different positions and poses with different expressions advantageously improves the model of that individual. This is important because the uncanny valley effect are derived from human perception and, more specifically, the neural processing performed by the human brain. Although it is commonly noted that humans “see a 3D world”, that is a misnomer. Rather, the human eye captures 2D images of the 3D world, and any 3D world that is seen by humans comes from the perception of our human brain by combining two 2D images from two eyes through our binocular human vision. Because this is perception that is generated by the brain processing the two 2D images seen by human eyes, the human brain is good at identifying very tiny differences between the real 3D world and artificially synthesized 3D world. That might explain why, although the similarity between the real 3D world and synthesized 3D world is improved in terms of quantitative measurements, the human perception thereof could get even worse. More specifically, the more details that come out of the synthesized 3D world, the more negative information our human perception might generate and cause the uncanny valley effect.

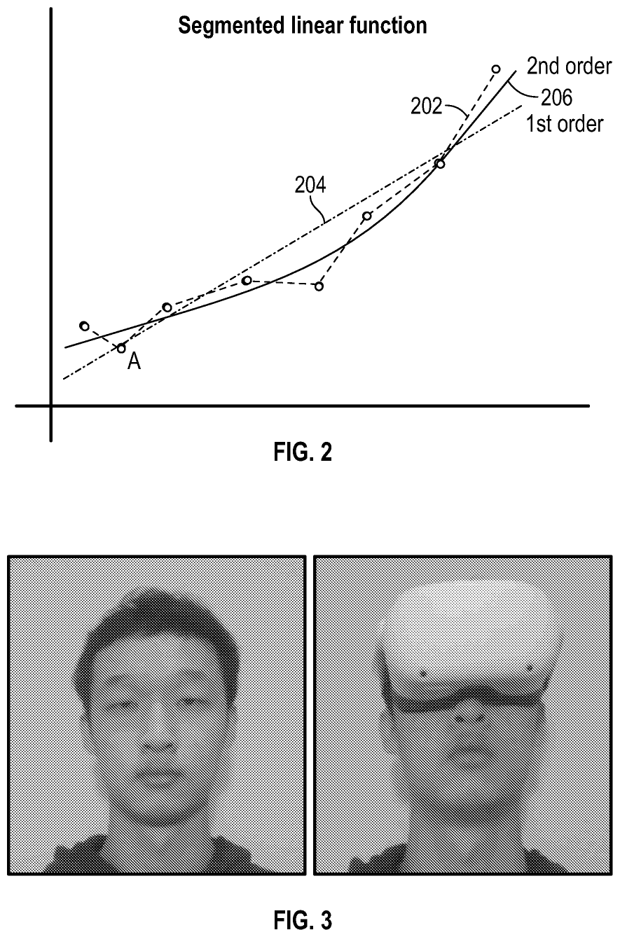

The present algorithm advantageously reduces the uncanny valley effect by using a plurality of real-captured images including information of a user and values of each sampling data point in the user's 3D face image that is obtained without HMD headset on the user's face. The importance of capturing and using a plurality of images is illustrated by the graph in FIG. 2. Assume that we have eight data samples (e.g. eight individual images of a user) which are shown as the dots on the line labeled 202. To find a model to fit these eight data samples a linear function, or a first order polynomial, may be used to generate a model to match these data points shown as the line labeled 204 (e.g. first order). In another embodiment, a quadratic function, or a second order polynomial, may be used to model the data points of line 202. This quadratic function is shown in the curve labeled 206 (e.g. second order). Mathematically, the second order polynomial should work better than the first order polynomial at the least for these eight data samples themselves. However, the second order polynomial could be worse due to the uncanny valley effect. In addition, even if the second order works better than the first order overall, the first order could still work better for some data points, as shown from point A in FIG. 2.

Given the possible uncanny effect typically associated with performing image processing to remove a portion of the captured image which includes the HMD and the uncertainty of models to use based on the sample points obtained from the captured images, the presently described algorithm makes use of a user-specific model built tightly around the sample points obtained from the images of the particular user being captured. This idea could be interpreted into two different aspects. The first aspect is that if we can directly use the sample points into the model, they should be used since they are best predictions we can obtain. The second one is that model is specific for each person which allows us to fit all obtained data points from the captures images similarly as how the eight data samples are fit in line 202 in FIG. 2. The model used as part of the image processing to remove the HMD from the captures image is not one that fits all users but one model per each user. By building and using a model trained on images of a single user, the model may make use of a linear function to allow for the best performance in real time. In addition, although we use segmented lines here, the model itself could be replaced by segmented quadratic functions, segmented CNN models, or even a look-up table based solution.

According to a second embodiment, the system obtains one or multiple 2D live reference images just before wearing the HMD. It is difficult to fully model real-word lighting in virtual reality or mixed reality due to the complexity of lighting itself. Each object in our real world, after receiving lights from other sources, will also work as a lighting source for other objects, and the final lighting we see on each object is the dynamic balance among all the possible lighting interactions. All these above make it extremely difficult to model the real world lighting using mathematical expressions such that the result may be used in image processing to generate an image for use with VR or AR applications.

Therefore, the present algorithm advantageously combines a predicted upper region of a face image with a real-time captured image of lower region of the face by obtaining a reference image captured immediately prior to a user placing the HMD on their head to advantageously adjust the lighting or texture of our image of the predicted region of the upper portion of the user's face. One example is shown FIG. 3 which depicts the live input reference image without HMD which provides image characteristic information such as information associated with lighting on the user and light reflected by the user. The image characteristic information includes dynamic lighting information which informs how the image of the user with the HMD removed should look like when the algorithm predicts the upper face region which corresponds to the blocked region from the image with HMD as shown on the right.

The present algorithm also makes use of one or more key images of the user that are captured and stored in a storage device. The key images include a set of images of the user captured by an image capture device when the user is not wearing an HMD apparatus. The key image represent a user having plurality of different views. The key images may include a series of images of the users face in different positions and making different expressions. The key images of the user are captured to provide a plurality of data points that are used by the model, in conjunction with the reference image, to predict the correct key image to be used as the upper face region provided when the HMD is removed from the live image of the user wearing the HMD is being captured. The reference images differ from the prerecorded key images which just need to be taken once. The reference image is a live image taken each immediately preceding the user placing the HMD on their face and prior to the user participating in a virtual reality (or augmented reality) application such as a virtual conference between a plurality of users at different (or same) locations where each user participating in the virtual conference is wearing an HMD and are having images of them being captured live but, in the virtual reality application, appear without the HMD on the face and instead appear within the virtual reality environment as they appear in the “real world”. This is advantageously made possible because of the HMD removal algorithm processing the live captured image of a user with the HMD and replacing the HMD in a rendered image shown to others in the virtual reality environment.

The live reference images could be one or multiple image depending on the lighting environment and model performance needs. In one embodiment, reference images are static and they are preselected based on predetermined knowledge on the movement of head, eyes and facial expressions. However, this is merely exemplary and they do not need to be static, and could vary. The selection of reference images will be dependent on analysis of the movement of a user's facial expression. For some users, only a few frames to cover all head movements and facial expressions. For others, the number of reference images may be a large number of video frames as reference images.

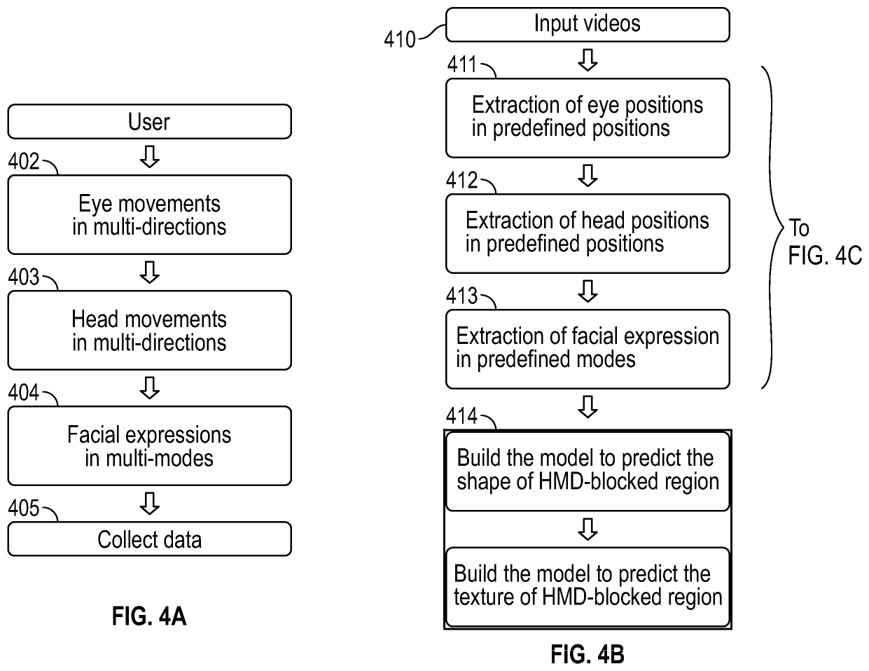

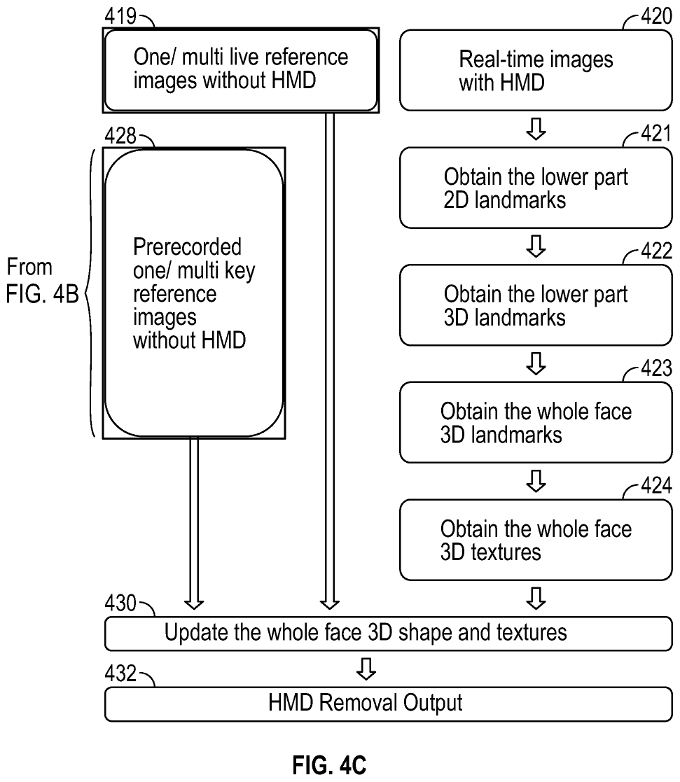

An exemplary workflow for removing the HMD according the present embodiments is provided below in the following algorithm. The workflow of the HMD removal algorithm can be separated into three stages, including data collection, training, and real-time HMD removal as shown in FIGS. 4A-4C with the first and second embodiments described above shown in the bordered steps of FIG. 4.

FIG. 4A illustrates the algorithm for the data collection phase which may be performed prior to execution of the HMD removal phase described in FIG. 4C. During the data collection phase, image capture of a user's phase is performed. In operation an image capture apparatus such as a video or still camera is controlled to capture a plurality of different images of the user. In 402, a capture process is performed to capture the face of the user where there are plurality of images where the eyes of the user are moving in different directions. In 403, a capture process is performed to capture the face of the user where there are plurality of images where the head of the user are moving in different directions. In 404, a capture process is performed to capture the face of the user where there are plurality of images where the user is making different facial expressions. Finally, in 405, data representing the plurality of images having different facial positions and characteristics are collected and stored in association with a particular user identifier that indicates that all images belong to a particular user. In operation, the data collection processing is performed using a device having a user interface and an image capture apparatus such as a mobile phone whereby one or more series of instructions can be displayed on the user interface and provide the user with guidance on what movements and expressions should be made a particular time so that sufficient amount of image data of the user are captured. These images captured during the data collection phase are the key images that are used to build the user specific model of the user as will be discussed later. More specifically, the data collection phase in FIG. 4A advantageously collects image data by varying different factors for the human face, such as eye movements, head movements, and facial expressions. The data collection phase of FIG. 4A can be done by instructing the user to move their eyes, heads and facial expressions according to some predefined procedures when they do not wear HMD. In one embodiment, the image data collected in the data collection phase may be a video whereby the user is moving the eyes, head and facial instructions as indicated by messages on a user interface display. In another embodiment, the data collection phase may be performed automatically whereby a user captures a video of them themselves spontaneously, and then an automatic analysis step will be placed here to categorize the scenarios into eye, head and facial expression movement.

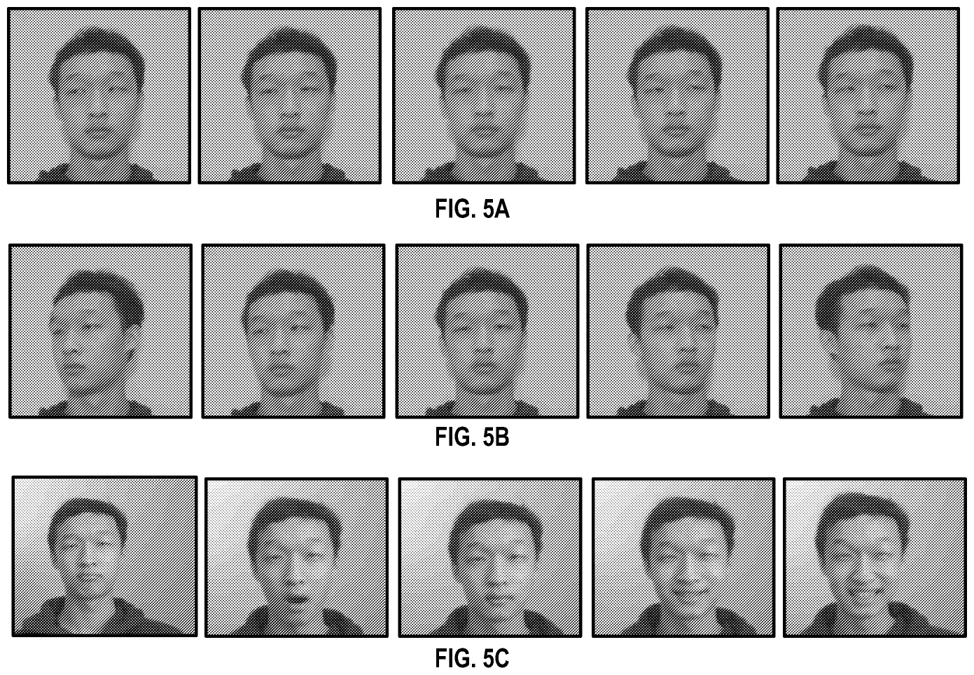

Exemplary images obtained in the image capture data collection phase of FIG. 4A are shown in FIG. 5A-5C. FIG. 5A-5C illustrate types of image data captured according to the data collection phase whereby images of a user performing different eye movements, head movement and facial expression without wearing HMD headset. In FIG. 5A, in response to instructions displayed on a user interface, a series of images (either individual still images or individual frames of a video image data) are captured where the user was instructed to make eye movements that begin looking to the right, then center and left while maintaining the head in a same position. In FIG. 5B, in response to instructions displayed on a user interface, a series of images (either individual still images or individual frames of a video image data) are captured where the user was instructed to make head movements by moving their head from the right to the left while maintaining a neutral eye position. In FIG. 5C, in response to instructions displayed on a user interface, a series of images (either individual still images or individual frames of a video image data) are captured where the user was instructed to make a plurality of different facial expressions at predefined time points so that images of the user making those expressions are captures. In one embodiment, a user is asked to make one or more normal (or neutral expressions), a happy expressions, a sad expression, a surprise expression, and an angry expression. These expressions are merely exemplary and depending on the need of the system and expected performance used in the virtual reality application to which this process is connected, the instructions being displayed on the user interface may instruct the user to make any type of emotional expression. The image data captured and illustrated in FIGS. 5A-5C are collected and analyzed and a predetermined number of key reference images are saved in memory. When the images are saved in memory, they may be affixed with a label that identifies the user and the particular movement or expression being made in the particular image. In another embodiment, the user image data may be collected the user interface requesting that the user perform a particular conversation or reading a preselected amount of text that causes the user to move in the desired manner such that key reference images can be captured as described above.

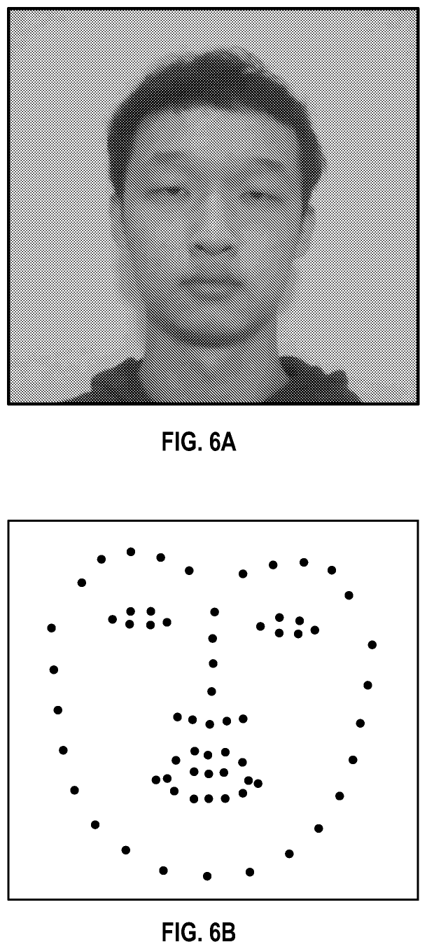

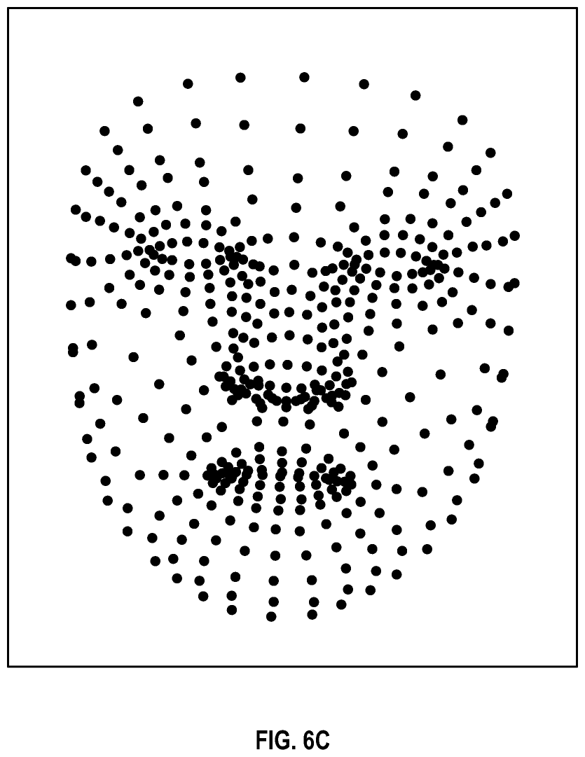

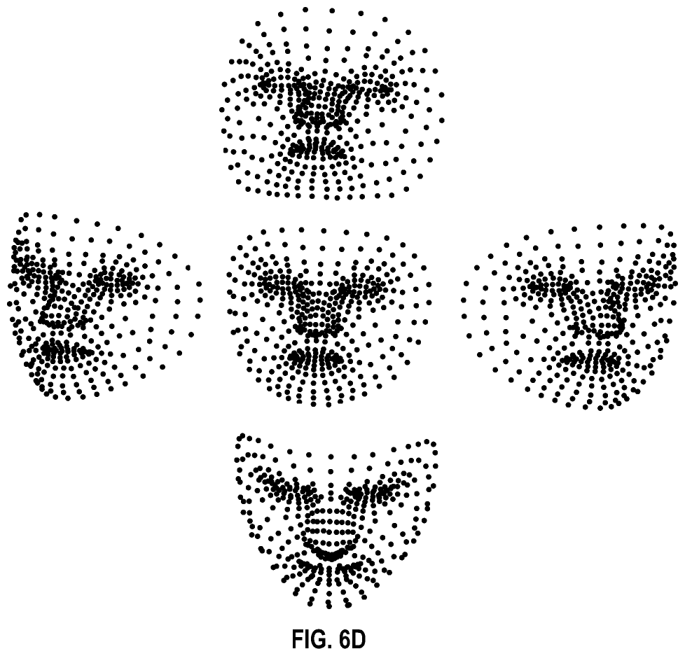

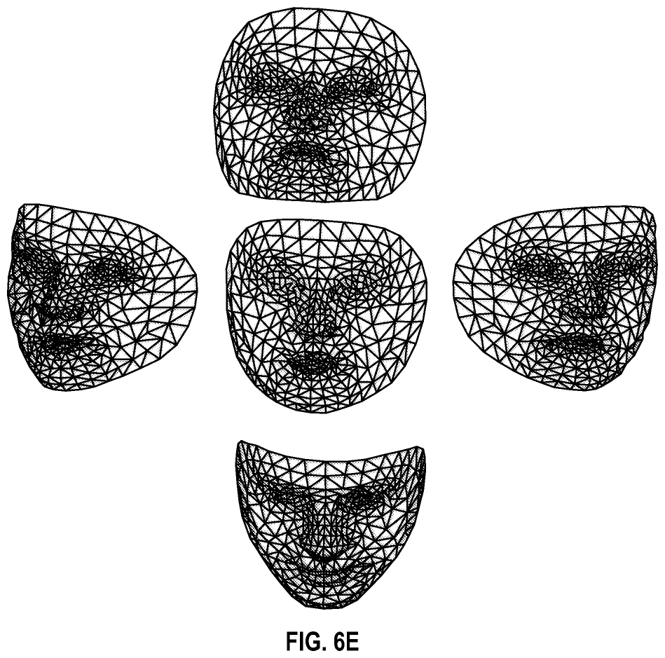

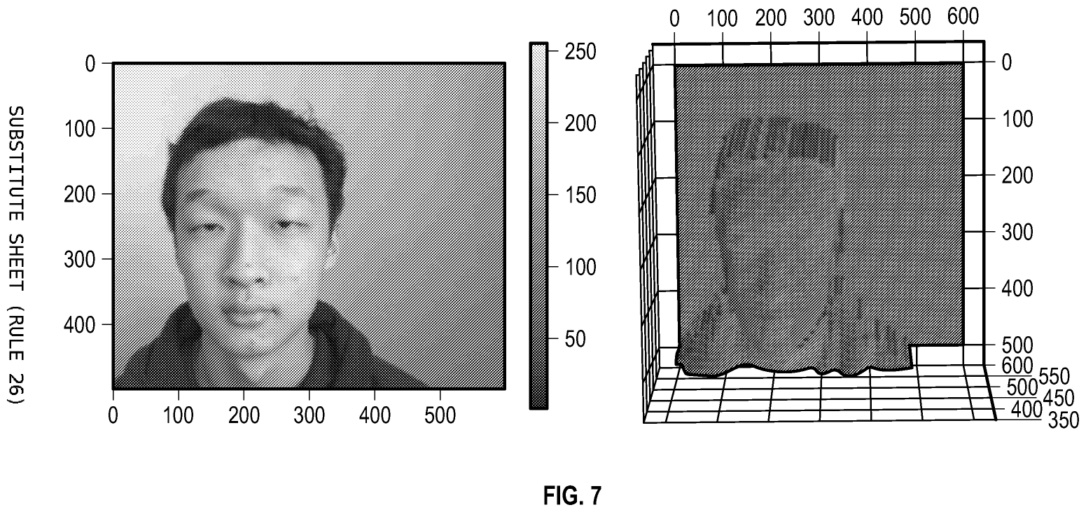

Once the key reference image data has been collected in FIG. 4A, the algorithm performs a training process shown in FIG. 4B. Our training includes two different processes, the first process is to extract and record the key reference images on our eye, head and facial expression movements from pre-collected data and the second portion is to use the image data to build the model that will be employed during the real-time HMD removal process in FIG. 4C. In step 410, the captured image data is input to the training module. In step 411, for each frame where a user's eyes are in one of the predefined positions, a portion of the respective image representing the eyes in the particular position are extracted as a first type of key reference image. Generally, these key reference images with eye portion are labelled based on their corresponding eye region features and pre-saved in a local or cloud storage. The key reference images are used as inputs during the real-time HMD removal processing to replace the eye region of an HMD image of a similar simulated eye region feature when a real-time HMD removal is running. In step 412, for each frame where a user's head is in one of the predefined positions, a portion of the respective image representing the eyes of the user when the head is in the particular position is extracted as a second type of key reference image. In step 413, for each frame where a user is performing one of the predefined facial expressions, a portion of the respective image representing the eyes of the user when the user is making that particular expression is extracted as a third type of key reference image. The first, second and third types of key reference images will be input directly to the real-time HMD removal processing described below in FIG. 4C. The extracted key reference images may be only one frame, or multiple frames of the data depending on the final performance required. In the second aspect of the training algorithm of FIG. 4B, a user specific model is built in 414 using the images captured during the data collection process of FIG. 4A. The user-specific model is built to predict the correct one of the first, second and third types of key reference images extracted in 411-413 are to be used by the HMD removal processing of FIG. 4C. In step 414, 2D and 3D landmarks are obtained from each image collected in the process of FIG. 4A. After obtaining the 3D landmarks from all the image data, the landmarks are divided into two categories: the upper face region and the lower face region. Examples of the landmark identification and determination performed in step 414 is shown in FIGS. 6A-6E and FIG. 7.

In steps 411-413, once the data is collected, the 3D shape and texture information of the user is extracted from images. Depending on the camera being used, there are two different ways to obtain this 3D shape information. If we are using RGB camera, the origin image does not contain depth information. Thus extra processing steps are performed to obtain the 3D shape information. Generally, landmarks of a human face as the clue for us to derive the 3D shape information of a user face. FIGS. 6A-6E illustrate how 3D shape information is determined. The following process is described with respect to a single image collected and this may represent any key reference image obtained in FIG. 4A. However, this processing is performed on all image data of the user collected to advantageously build 3D facial information that is specific to the user. In FIG. 6A a sample image of the users face is obtained. In obtaining this image, the system knows the type of image and during which capture mode (e.g. eye movement, head movement or expression capture) the image was captured. FIG. 6B illustrates a predetermined number of facial landmarks that can be identified using facial landmark identification processing such as may be performed using a publicly available library DLIB. As shown in FIG. 6B, 68 2D landmarks were extracted. To convert the obtained 2D landmarks into 3D landmarks, a series of prebuilt 3DMM face models data is used to derive the depth information that are likely associated with the obtained 2D landmarks. In another embodiment, FIG. 6C illustrates obtaining 3D landmarks directly from the 2D image without need to go through 2D landmarks. In this embodiment, 468 3D landmarks were extracted directly from 2D images using publicly available software—Mediapipe. Once the 3D landmarks are obtained, FIG. 6D illustrates how these 3D landmarks look like from different viewing directions. In FIG. 6E, one or more triangular meshes are generated from the determined 3D landmarks and is illustrated from the different viewing directions similar to the directions shown in FIG. 6D. The result is each user a plurality of 3D triangular face meshes built based on the images captured during the data collection processing.

While a linear algebra model is used here to estimate the landmark of entire face, however this process can also be replaced by any deep learning models. In addition, since the 3D landmarks of our face naturally form a graph, we could also take the approach of Graph Convolutional Networks (GCN) to allow the mapping of 2D face to 3D landmarks, as well as the simulation of 3D landmarks of our facial expression.

Because a key stage in our HMD removal is to extract and record the 3D shape information of the whole face of the particular user. The algorithmic processing can be performed using both RGB image capture apparatus and RGBd image capture apparatus which can obtain depth information during the image capture process. As described above with respect to FIGS. 6A-6E, for an RGB image capture apparatus, steps to recover the 3D shape of a person's face are performed using a 3DMM model to allow the mapping from 2D landmarks to 3D vertices, so we can estimate 3D information from 2D images. Some other approaches use a prebuilt AI model that is often trained by using real 3D scan data or artificially generated 3D data from 3DMM. However, this conversion processing is not needed if the image capture apparatus is an RGBd camera. All the depth information for each image are available once captured through the RGBd camera. Therefore, we do not need step of using 3DMM model to derive the depth information for the face of the user. Instead, If we have RGBd camera, 3D shape information of the whole face is directly obtained during the image capture process. This example is shown in FIG. 7.

FIG. 7 depicts a first color 2D image captured during the data collection processing. When the image capture process is performed using an RGBd camera, depth information associated with the 2D is also obtained and illustrated in the graph in FIG. 7. In this embodiment, in response to identifying one or more face landmarks, the 3D shape information of these landmarks can be derived at the same time. Given all the obtained landmarks, texture information from the face were also extracted and would be used for our real-time HMD removal.

Turning back to the training phase of FIG. 4B, a model is built using the captured images in the data collection phase in step 414 to predict the 3D landmarks of upper face region from the 3D landmarks of lower face region. The model here could be just the shape model, or both the shape and texture models of 3D landmarks.

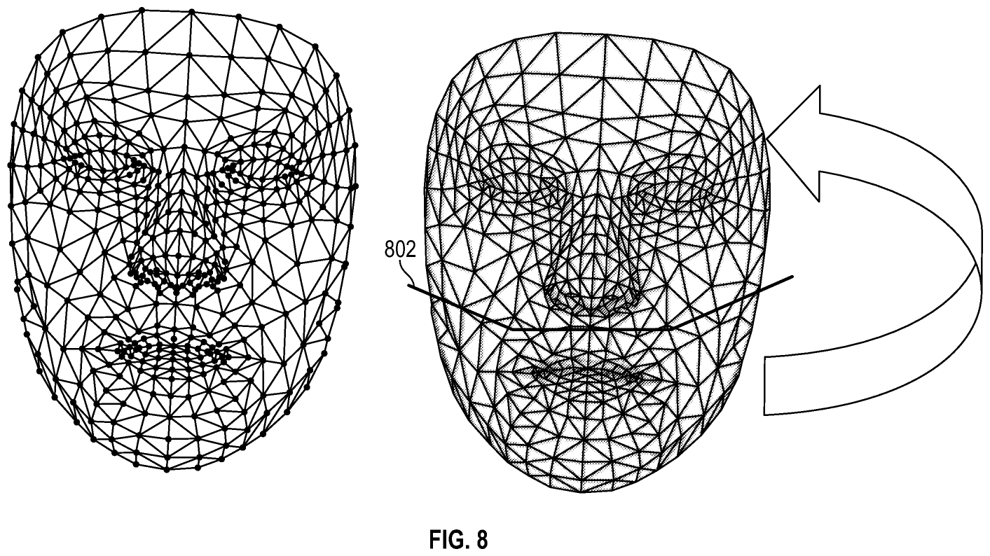

Once the 3D shape of all landmarks or vertices in each image are obtained, they are together and separated them into two categories, one upper face and one lower face, as shown in FIG. 8. On the left shows an example of all the vertices and meshes obtained superimposed on one image. On the right shows the separation made between the upper face and the lower face with line 802 representing a separation point between upper and lower portions of the face. The lower part of the face can be obtained directly from the real-time captured images after the user is wearing the HMD and which is captured while the real-time HMD removal processing is being performed, but the upper part of the face can only be visible during the training stage when the user is not wearing the HMD and both the upper face and lower face are visible.

The model built in step 414 is user specific and does not rely on face information of other users. Since all the 3D facial data is derived from the individual user, the complexity required in the model is significantly reduced. For the 3D shape information, depending on the final precision needed, a linear least-square regression may be the function used to build the model. Below is a description of how the obtained data is used to generate our predictive model to predict upper part face from lower part face. For each image, we are able to obtain 468 3D landmarks as shown on the left in FIG. 8. Of those landmarks, the algorithm classifies a number of vertices representing each of the upper face portion and the lower face portion. As shown herein on the right image of FIG. 8, 182 vertices were classified as the lower part face shown below line 802 whereas the other 286 vertices were classified as the upper face shown above line 802.

Given 1000 images in our training dataset, we use L_{face}, U_{face} and M_{LU} to represent the 3D vertices in the lower part face, 3D vertices in the upper part face, and the model being built during the training process. The model M_{LU} predicts the upper 3D vertices directly from the lower 3D vertices. Note that all the 3D coordinates of vertices need to be flattened to perform computational processing. For example, given the 182 vertices in the lower face, there are 546 elements at each row in L_{face} shown here:

$${L}_{face} = ( \begin{matrix}{x}_{11} & {x}_{12} & … & {x}_{1546} \\ {x}_{21} & {x}_{22} & … & {x}_{2546} \\ ⋮ & ⋮ & ⋱ & ⋮ \\ {x}_{10001} & {x}_{10001} & … & {x}_{1000546}\end{matrix} )$$

Similarly, there are 858 elements from 286 vertices at each row in U_{face}

$${U}_{face} = ( \begin{matrix}{y}_{11} & {y}_{12} & … & {y}_{1858} \\ {y}_{21} & {y}_{22} & … & {y}_{2858} \\ ⋮ & ⋮ & ⋱ & ⋮ \\ {y}_{10001} & {y}_{10001} & … & {y}_{1000858}\end{matrix} )$$

As such, the resulting model M_{LU} is represented as follows:

$${M}_{LU} = ( \begin{matrix}{m}_{11} & {m}_{12} & … & {m}_{1858} \\ {m}_{21} & {m}_{22} & … & {m}_{2858} \\ ⋮ & ⋮ & ⋱ & ⋮ \\ {m}_{5461} & {m}_{5461} & … & {m}_{546858}\end{matrix} )$$

The error of a linear regression model can then be written in Equation 1.

$$E = {U}_{face} - {L}_{face} \times {M}_{LU} \qquad Equation 1$$

The goal of least square is to minimize the mean square error E from the model prediction, and the solution is provided in Equation 2

$${M}_{LU} = {( {L}_{face}^{T} {L}_{face} )}^{- 1} {L}_{face}^{T} {U}_{face} \qquad Equation 2$$

The model M_{LU} is a user specific model that is generated and stored in memory and associated with a particular user identifier such that, when the user associated with the user identifier is participating in a virtual reality application, the real-time HMD removal algorithm will be performed while live capture images of that user wearing the HMD are being captured so that a final corrected image of the user will appear to other participants (and themselves) in the virtual reality application as if the real-time capture is occurring without an HMD occluding the portion of the user's face. The user if linear regression is but the possible model used for the prediction but this should not be seen as limiting. Any model, including nonlinear least square, decision tree, CNN-based deep learning techniques, or even a look-up table based model may be used. Further reducing the complexity of the model is the need to not have to build the model for texture information of the upper face because the upper face portions extracted in 411-413 are used to use prerecorded reference images for replacement purposes during the HMD removal process. In another embodiment, the model building step builds a second model that predicts texture information for the upper portion of the face if prerecorded face images is insufficient to represent all the varieties of face textures on different lighting or facial expression movements.

Turning back to FIG. 4C, the real-time HMD removal processing that is performed on a live captured image of a user wearing an HMD while the user is participating in a virtual reality application is described. Before the HMD removal, one or multiple live reference images of the user without HMD are recorded immediately preceding the user positioning the HMD to occlude a portion of the face and will be used in step S419 described below. Capturing one or more live reference images immediately preceding participation in a virtual reality application where HMD removal processing is being performed is key to adapt one or more characteristics (such as lighting, facial features, or other textures) associated with replacement upper portion used during HMD removal processing.

In step 420, for each image captured in real time of the user wearing the HMD, 2D landmarks of the lower part face are obtained in step 421, and 3D landmarks from these 2D landmarks are derived in step 422. This extraction and derivation is performed in a similar manner as was done during the training phase and described above. In response to determining the 3D landmarks of the lower face region, 3D landmarks of the upper face are estimated in step 423. This estimate is performed by combing the upper face of pre-saved key reference images in data collection with the lower face of real-time live image, and then a 3D landmark model is applied to the combined images to create the 3D landmarks of the entire face, including both the landmarks of upper and lower face. In step 424, an initial texture model is also obtained for these 3D landmarks to synthesize an initial 3D face without HMD. Finally, the one or multi live reference image without HMD captured in step 419 which is captured recorded just before participation in the virtual reality application is update the lighting applied to the resulting image. As such, in step 430, the algorithm uses the one or more types of key images obtained from the training process in FIG. 4B in step 428 in combination with one or more live reference images obtained in step 419 and the output of steps 420-428 to update facial 3D shape and textures to be applied when generating the output image of the user in real-time with the HMD removed such that the user appears, in the virtual reality application, as if that user is being captured in real-time and was never wearing the HMD.

Exemplary operation will now be described. After the model has been built according to the training of FIG. 4B, the model is advantageously used to predict the shape and texture information of upper face (step 430 in FIG. 4C), the HMD removal processing can begin. Just before wearing HMD, at least one user front image of the user without HMD headset with current live view lighting conditions are captured (419 in FIG. 4C). The reason behind it is that we need some live reference image just prior to participation in a virtual reality application such as a virtual meeting to provide some anchor points to balance the pre-capture lighting conditions derived from the lighting conditions present when the key references images were captured during data collection and training (FIGS. 4A and 4B) and current lighting conditions from the lighting from live capture images.

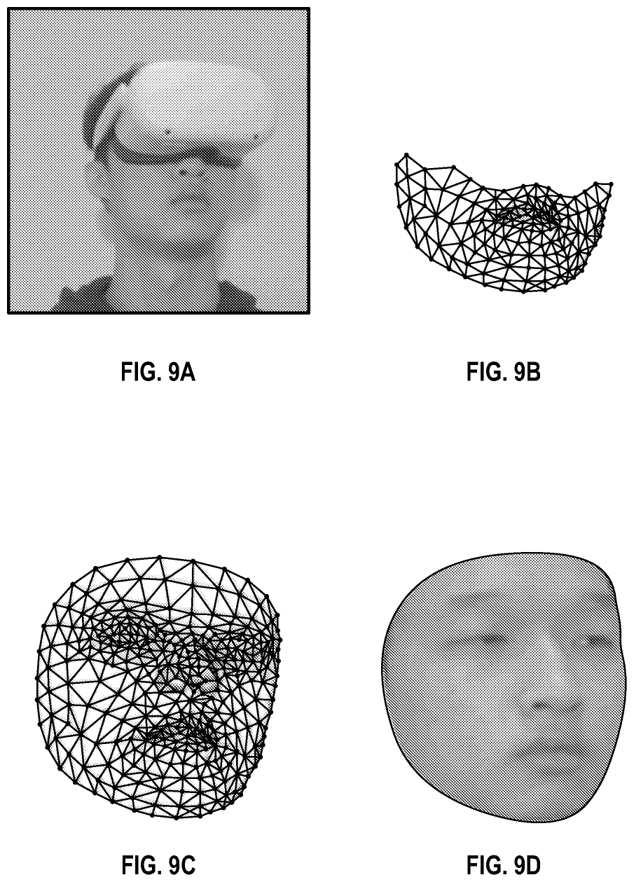

After the recording of one or multi live reference image, the real-time HMD removal processing begins as illustrated in visually in FIG. 9. In FIG. 9A, a current real-time captured image of a user having the HMD positioned on their face is shown. In FIG. 9B, from the live captured image, 2D (and eventually 3D) facial landmarks of the user's face are determined. As can be seen, this determination necessarily omits the upper face region which is occluded by the HMD worn by the user. FIG. 9C illustrates a whole face 3D vertices mesh obtained after combined the real-time captured lower face region in FIG. 9B and the predicted upper part of face obtained using the model which was determined by the trained model which was trained understand what the upper region of the face is likely to be for a given lower face region at a given time. Based on this combined mesh (430 in FIG. 4c), the final output image is generated by updating the intermediate output 3D mesh using one or more the first, second or third types of key reference images extracted in FIG. 4B and provided as input in 428 of FIG. 4C along with the live reference image captured in 419 in FIG. 4C. Once we recover the blocked face region under HMD and build the face as what we showed in FIG. 9, the corrected image is attached back to the 3D mesh representing the user's head. These 3D head could be prebuilt using the 2D images without HMD. The stitch of HMR-removed face into the full-head structure could be done using the boundary of face we identify through the 3D landmark detection as shown in FIG. 8. As such, the result as shown in FIG. 9D is a corrected image of the user in real-time while the user is wearing the HMD but is provided in the virtual reality application as an image of the user as if the user is not wearing the HMD at that moment. This advantageously improves the real-time communication between the users without negative impacts associated with the uncanny valley effect because the models used to make the prediction and correction are user-specific.

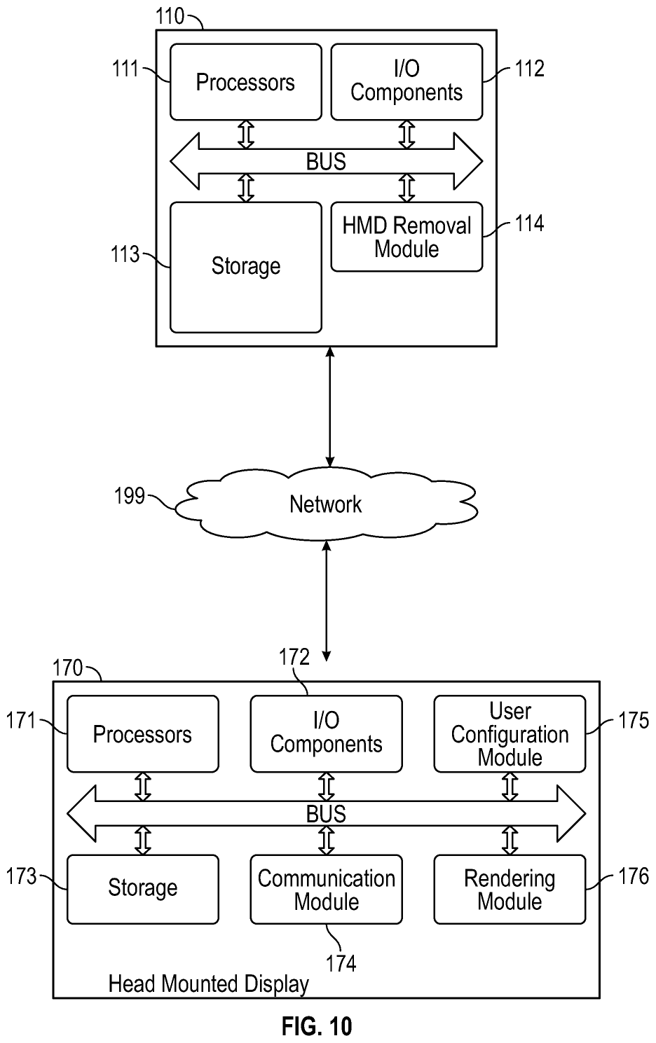

FIG. 10 illustrates an example embodiment of a system for removing head mount display from a 3D image The system includes a server 110 (or other controller), which is a specially-configured computing device and head mount display apparatus 170. In this embodiment, the server 110 and the head mount display apparatus 170 communicate via one or more networks 199, which may include a wired network, a wireless network, a LAN, a WAN, a MAN, and a PAN. Also, in some embodiments the devices communicate via other wired or wireless channels.

The server 110 includes one or more processors 111, one or more I/O components 112, and storage 113. Also, the hardware components communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 111 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 112 include communication components (e.g., a graphics card, a network-interface controller) that communicate with the head mount display apparatus, the network 199 and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storage 113 includes one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 1003, which may include both ROM and RAM, can store computer-readable data or computer-executable instructions.

The server 110 includes a head mount display removal module 114. A module includes logic, computer-readable data, or computer-executable instructions. In the embodiment shown in FIG. 11, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 113. Also, in some embodiments, the lighting-condition-detection device 1100 includes additional or fewer modules, the modules are combined into fewer modules, or the modules are divided into more modules.

The HMD removal module 114 contains operations programmed to carry out HMD removal functionality described hereinabove.

The Head Mount Display 170 contains hardware including one or more processors 171, I/O components 172 and one or more storage devices 173. This hardware is similar to processors 111, I/O components 112 and storage 103, the descriptions of which apply to the corresponding component in the head mounted display 170 and is incorporated herein by reference. The head mounted display 170 also includes three operational modules to carry information from server 110 to display for the user. Communication module 174 adapts the information received from network 199 for the use HMD display 170. User configuration module 175 allows the user to adjust how the 3D information would be displayed on the display of the head mounted display 170 and rendering module 176 finally combines all the 3D information and users configuration to render the images into the display.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

The scope of the present invention includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A server for removing an image of a first apparatus that occludes a portion of a face of a first user in a video stream comprising:
one or more processors; and
one or more memories storing instructions that, when executed, configure the one or more processors to:
receive captured video data of the first user wearing the apparatus that occludes the portion of the face of the first user;
obtain first type of reference images of the first user including the occluded portion and non-occluded portion of the face of the first user;
acquire lighting information corresponding to lighting of the first user in the captured video stream;
generate data of the first user including a full face image using a trained machine learning model based on the obtained first type of reference images; and
causing the generated data of the user to be displayed on a display of a second apparatus that occludes a portion of a face of a second user.

2. The server according to claim 1, wherein execution of the instructions further configures the one or more processors to:
obtain, from the first type of reference images stored in a storage device, facial landmarks representing an entire face of the first user including the occluded portion and non-occluded portion of the face of the first user;
provide, as an input to the trained machine learning model, a second type of reference images of the first user not wearing the first apparatus captured during a live image capture process at time preceding capturing of the video data that includes the lighting information;
generate the data of the first user by using the lighting information to select a region from the one or more of the first type of reference images corresponding to the first apparatus.

3. The server according to claim 1, wherein the lighting information includes information characterizing lighting applied to the first user and light being reflected from the first user not wearing the first apparatus.

4. The server according to claim 1, wherein the trained machine learning model is user specific and trained using a set of reference images of the first user to identify facial landmarks in each reference image of the set of references images and predict an upper face image from at least one of the first type of reference images used when removing the image of the first apparatus that occludes the face of the first user.

5. The server according to claim 4, wherein the trained machine learning model is further trained to use, a live captured image of a lower face region with lower face regions from the set of reference images to predict facial landmarks for an upper face region that corresponds to the live captured image of the lower face region.

6. The server according to claim 4, wherein the data of the full face image is three dimensional data generated using extracted upper face regions of the set of reference images that are mapped onto the upper face region in the live captured image of the first user to remove the upper face region occluded by the first apparatus.

7. The server according to claim 1, wherein execution of the instructions further configures the one or more processors to
obtain first facial landmarks of a non-occluded portion of the face;
obtain second facial landmarks representing the entire face of the user including the occluded portion and non-occluded portion of the face of the user; and
provide one or more types of reference images of the user with the first and second obtained facial landmarks to the trained machine learning model to remove the apparatus from the received captured video data.

8. A computer implemented method for removing an image of a first apparatus that occludes a portion of a face of a first user in a video stream comprising:
receiving captured video data of the first user wearing the first apparatus that occludes the portion of the face of the first user;
obtaining first type of reference images of the first user including the occluded portion and non-occluded portion of the face of the first user
acquiring lighting information corresponding to lighting of the first user in the captured video stream;
generating data of the first user include a full face image using a trained machine learning model based on the obtained first type of reference images; and
causing the generated data of the first user to be displayed on a display of a second apparatus that occludes a portion of a face of a second user.

9. The method according to claim 8, further comprising
obtaining, from the first type of reference images stored in a storage device, facial landmarks representing an entire face of the first user including the occluded portion and non-occluded portion of the face of the first user;
providing, as an input to the trained machine learning model, a second type of reference images of the first user not wearing the first apparatus captured during a live image capture process at time preceding capturing of the video data that includes the lighting information;
generating the data of the first user by using the lighting information to select a region from the one or more of the first type of reference images corresponding to the first apparatus.

10. The method according to claim 8, wherein the lighting information includes information characterizing lighting applied to the first user and light being reflected from the first user.

11. The method according to claim 8, wherein the trained machine learning model is user specific and trained using a set of reference images of the first user to identify facial landmarks in each reference image of the set of references images and predict an upper face image from at least one of the first type of reference images used when removing the image of the first apparatus that occludes the face of the first user.

12. The method according to claim 11, wherein the trained machine learning model is further trained to use, a live captured image of a lower face region with lower face regions from the set of reference images to predict facial landmarks for an upper face region that corresponds to the live captured image of the lower face region.

13. The method according to claim 12, wherein the data of the full face image is three dimensional data generated using extracted upper face regions of the set of reference images that are mapped onto the upper face region in the live captured image of the first user to remove the upper face region occluded by the first apparatus.

14. The method according to claim 8, further comprising:
obtaining first facial landmarks of a non-occluded portion of the face;
obtaining second facial landmarks representing the entire face of the user including the occluded portion and non-occluded portion of the face of the user; and
providing one or more types of reference images of the user with the first and second obtained facial landmarks to the trained machine learning model to remove the apparatus from the received captured video data.
